(19) United States
(12) Patent Application Publication
(10) Pub. No.: US 2004/0076937 A1
(43) Pub. Date: Apr. 22, 2004

(54) System and method for daily biblical meditation

(76) Inventor: Derrick A. Howard, Desoto, TX (US)

Correspondence Address: Michael L. Diaz, Michael L. Diaz, P.C., 555 Republic Drive, Suite 200, Plano, TX, 75074, US

(21) Appl. No.: 10/271,600

(22) Filed: Oct. 16, 2002

(51) Int. Cl. G09B 19/00

(52) U.S. Cl. 434/245; 434/317

(57) ABSTRACT

A method and system for assisting an individual in daily meditation upon the Bible. The system includes a textual display providing information and inspiration on a specific passage of the Bible. The system also includes a voice recorder/player for recording a desired biblical verse. The recorded verse is played back by the individual as desired to assist in the memorization of the verse. The textual display is pocket sized for easy transportation and convenient referral by the individual. In addition, the voice recorder/player is shaped in the appearance of a Bible and is also pocket sized for convenient carriage.

### BACKGROUND OF THE INVENTION

1. Technical Field of the Invention

This invention relates to meditation and, more particularly, to a system and method for daily biblical meditation.

2. Description of Related Art

Daily meditation upon the Bible and its teachings is well known throughout the world. To benefit from the teachings and revelations of the Bible, constant study and meditation is necessary. It is quite common for a person to study a small section of the Bible each day. In this way the person may meditate on that selection portion of the Bible. Additionally, it is often found helpful to memorize selected verses from the Bible. Memorization of selected verses is often helpful in the internalization of the teachings of the selected verses.

However, although daily meditation on selected portions of the Bible are helpful for understanding and following the teachings of the Bible, it is often difficult to meditate upon the selected passages over a small period of time. Rather, it is advantageous to contemplate the selected passage throughout the day. Additionally, except for those that have extremely good memories, it often takes a longer period of time to memorize the selected verse. However, in a person's daily life, it is often difficult to find the time, equipment, or discipline to meditate in small periods of time throughout the entire day. A system and method are needed which enables a person to study a selected passage of the Bible, as well as memorized a desired biblical verse.

Thus, it would be a distinct advantage to have a system and method which assists a person in the person's daily meditation of the Bible, as well as assist in the memorization of a desired biblical verse. It is an object of the present invention to provide such a system and method.

### SUMMARY OF THE INVENTION

In one aspect, the present invention is a system for daily meditation of the Bible. The system includes a textual display providing textual information on a biblical topic and a voice recorder/player for recording a selected biblical verse from the textual display. A user periodically studies the textual display and records the selected biblical verse for playback. The playback of the biblical verse assists the user in the memorization of the biblical verse.

In another aspect, the present invention is a method of assisting a user in daily biblical meditation. The method begins by the user selecting a daily meditation displayed on a textual display. Next, the user studies the textual display. The user also records into a voice recorder/player a desired biblical verse. The user carries the textual display and the voice recorder/player. The textual display is periodically reviewed by the user. In addition, the recorded verse is replayed by the user to assist in memorizing the recorded verse.

In still another aspect, the present invention is a system for daily meditation of the Bible. The system includes a textual display providing textual information on a biblical topic. The textual display is pocket sized for personal carriage by the user. The system also includes a voice recorder/player for recording a selected biblical verse from the textual display. The voice recorder/player is pocket sized for personal carriage by the user and has an appearance of the Bible. A user periodically studies the textual display and records the selected biblical verse for playback. The playback of the biblical verse assists in the memorization of the biblical verse.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for biblical meditation by a user in the preferred embodiment of the present invention;

FIG. 2 is an enlarged front view of the voice recorder/player of the system of FIG. 1;

FIG. 3 is an enlarged front view of the textual display of the system of FIG. 1;

FIG. 4 is a flow chart outlining the steps for meditating on a specified biblical passage according to the teachings of the present invention;

FIG. 5 is a front view of a partitioned heart in an alternate embodiment of the present invention; and

FIG. 6 is a simplified block diagram illustrating the components of a system for biblical meditation by a husband and a wife in an alternate embodiment of the present invention

### DETAILED DESCRIPTION OF EMBODIMENTS

The present invention is a system and method for assisting an individual in daily meditation of the Bible.

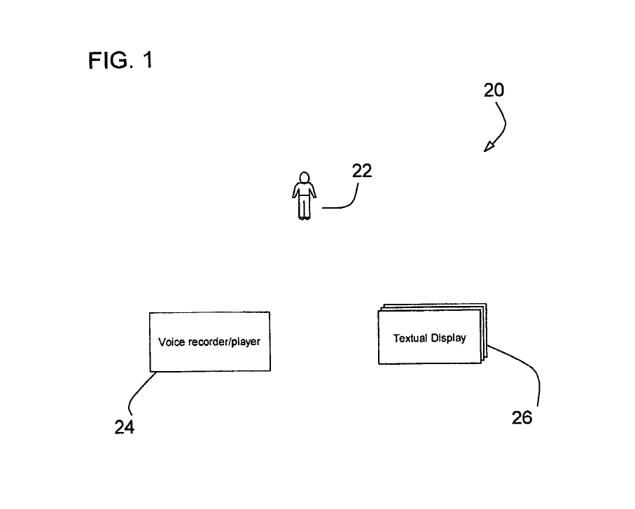

FIG. 1 is a simplified block diagram illustrating the components of a system 20 for biblical meditation by a user 22 in the preferred embodiment of the present invention. The system includes a voice recorder/player 24 and a pocket-sized textual display 26. The voice recorder/player and the textual display are sized and shaped to be carried by the user 22 in a convenient manner throughout the day.

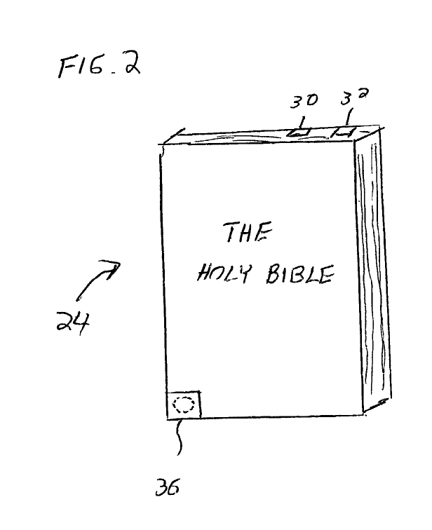

FIG. 2 is an enlarged front view of the voice recorder/player 24 of the system 20 of FIG. 1. The voice recorder/player 24 is preferably configured in the shape and outward appearance of a Bible. The outer appearance of a Bible is well known and typically includes a black exterior surface and the inscription “The Holy Bible” displayed on the front of the Bible. The voice recorder/player may be any device allowing the storage of a verbal recording within the recorder/player. Additionally, the voice recorder/player must be able to play back the recorded message. Any common voice recorder/player device may be utilized. In the preferred embodiment of the present invention, the voice recorder/player requires only the storage of approximately 20 seconds to store a selected biblical verse. However, any device may be utilized. Additionally, the voice recorder/player is preferably small enough to fit within a shirt or pant pocket for easy transportation of the voice recorder/player.

The voice recorder/player includes a record button 30 and a playback button 32. Additionally, the voice recorder is powered by a power supply 36, which may be a conventional dc battery.

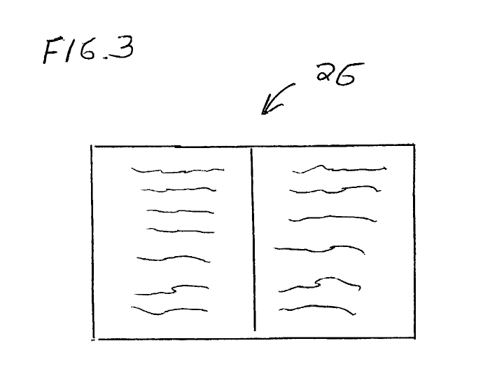

FIG. 3 is an enlarged front view of the textual display 26 of the system 20 of FIG. 1. The textual display is a pocket sized booklet which may be stored within a shirt or pant pocket of the user 22. The textual display may be one or more pages of inspiration, which may include selected passages of the Bible as well as commentary from theologians. Additionally, the textual display may include a selected passage from the Bible which is selected for memorization by the user. In the preferred embodiment of the present invention, the textual display may include a plurality of daily meditation themes incorporated within one booklet. In an alternate embodiment of the present invention, each daily meditation text may be displayed on a separate textual display. The booklet is preferably constructed of a resilient, water resistance material, such as a plastic coated paper.

With reference to FIGS. 1-3, the operation of the system 20 will now be explained. The textual display 26 is read by the user 22 at the beginning of the day. The textual display includes a daily verse provided for memorization by the user. The user studies the verse. In addition, the user depresses the record button 30 and verbalizes the verse into the voice recorder/player 24. The user then carries the voice recorder/player and the textual display. Both the textual display and the voice recorder/player are small enough to be carried within pockets on the clothing of the user. Throughout the day, the user continues to study the textual display and its daily inspiration. Additionally, the user attempts to memorize the recorded verse. As needed, the user may depress the playback button 32 and hear the verbalized verse. Through the constant playback of the recorded verse, the user may more easily memorize the verse.

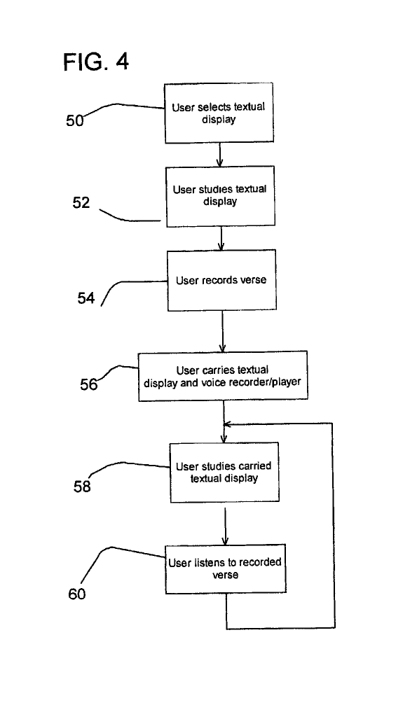

FIG. 4 is a flow chart outlining the steps for meditating on a specified biblical passage according to the teachings of the present invention. With reference to FIGS. 1-4, the steps of the method will now be explained. The method begins with step 50 where the user 22 selects a daily inspiration/passage from the textual display 26. The daily inspiration includes commentary on a particular passage of the Bible as well as a selected biblical verse for memorization by the user 22. Next, in step 52, the user studies the selected daily inspiration from the textual display. Preferably, this selected daily inspiration is read at the beginning of the user's day. In step 54, the user depresses the record button 32 of the voice recorder/player 24 and verbalizes the desired biblical verse selected for memorization. Next, in step 56, the user carries the textual display and the voice recorder/player for the rest of the day.

The method then continues with step 58, where periodically through the day/night, the user studies the textual display 26 with its daily inspiration. Additionally, in step 60, the user 22 periodically depresses the playback button 32 and listens to the recorded verse. The user repeats steps 58 and 60 throughout the day as desired. The playback of the recorded verse assists the user in memorizing the recorded message. The entire process begins each day with a selection of a new daily inspiration from the textual display or another separate textual display.

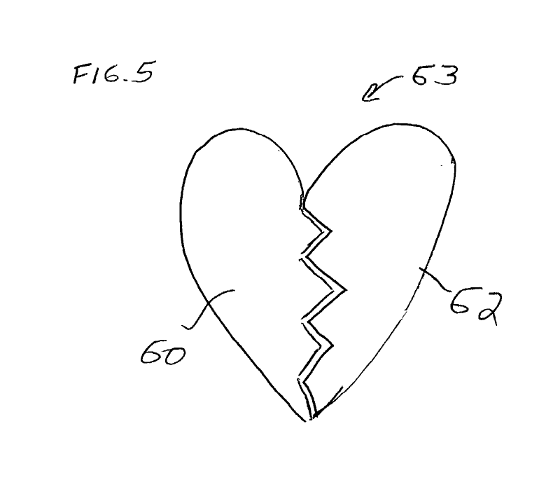

FIG. 5 is a front view of a partitioned heart 63 in an alternate embodiment of the present invention. The partitioned heart is well known. It symbolizes the love between a husband and wife and their relationship with each other and God. The partitioned heart is two separate sections 60 and 62 which when placed adjacent to each other forms a heart. The side portion of each section adjacent to the corresponding section includes an irregular edge which fits into an opposing irregular edge. The partitioned heart is separated, with one section 60 being carried by the husband and the other section 62 being carried by the wife.

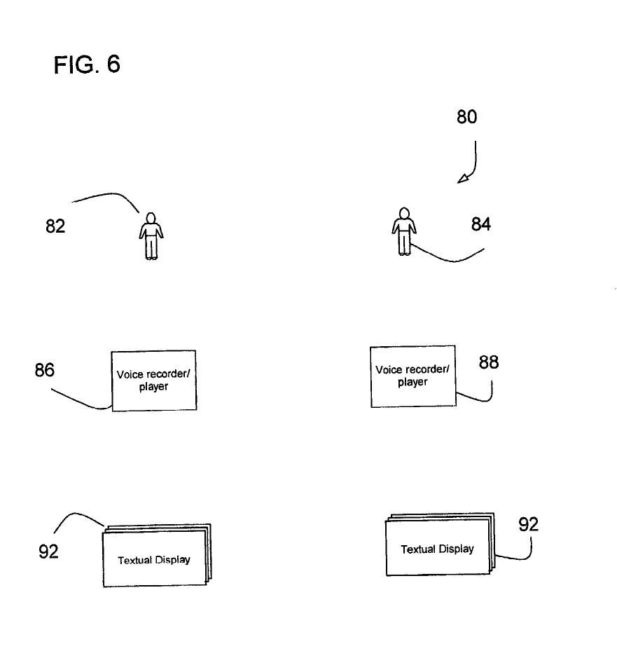

FIG. 6 is a simplified block diagram illustrating the components of a system 80 for biblical meditation by a husband 82 and a wife 84 in an alternate embodiment of the present invention. The system 80 includes a first voice recorder/player 86 shaped as one section 60 carried by the husband. A second voice recorder/player 88 is shaped as the section 62 and is carried by the wife 84. In addition, the husband carries a textual display 90 and the wife carries a textual display 92.

With reference to FIGS. 5 and 6, the system 80 will now be explained. The textual display 92 is read by the husband 82 and the wife 84 at the beginning of the day. The textual display may include topics related to marriage, relationships from a biblical perspective. The husband and wife study the textual display. In addition, the husband records a biblical verse in the voice recorder/player 88 for playback by the wife 84. The wife also records a biblical verse in the voice recorder/player 86 for playback by the husband. Both the wife and husband carry their textual display and voice recorder/player. Both the textual display and the voice recorder/player are small enough to be carried within pockets on the clothing of the husband or wife. Throughout the day, the husband and wife individually continue to study the textual display and its daily inspiration. Additionally, both the husband and wife attempt to memorize the recorded verse. As needed, the husband or wife may replay the recorded verse from the voice recorder/player and hear the verbalized verse. Through the constant playback of the recorded verse, the husband/wife may more easily memorize the verse. Each voice recorder/player is shaped in one of the sections 60 or 62, to provide a constant reminder of the relationship that the husband and wife have with each other.

The textual display 88 may be in any format. Preferably, a plurality of booklets may be utilized and relate to many topics and concerns of marriage. In the system 80, the system is utilized to strengthen the relationship between and husband and wife.

The present invention provides many benefits to the users of the systems. The system and method enable an individual to meditate upon various biblical subjects in a convenient manner throughout the individual's day. In addition, the voice recorder/player provides an assistance to the individual in memorizing a desired biblical verse. The system provides the voice recorder/player in the appearance of the Bible. Additionally, the system may be utilized by a husband and wife to develop and strengthen their marriage from a biblical perspective.

It is thus believed that the operation and construction of the present invention will be apparent from the foregoing description. While the method and system shown and described have been characterized as being referred, it will be readily apparent that various changes and modifications could be made therein without departing from the scope of the invention as defined in the following claims.

What is claimed is:

1. A system for daily meditation of the Bible, the system comprising:
a textual display providing textual information on a biblical topic; and
a voice recorder/player for recording a selected biblical verse from said textual display;
whereby a user periodically studies said textual display and records the selected biblical verse for playback, the playback of the biblical verse assisting in the memorization of the biblical verse.

2. The system for daily meditation of the Bible of claim 1 wherein said voice recorder/player is configured in an appearance of the Bible.

3. The system for daily meditation of the Bible of claim 2 wherein said voice recorder/player is pocket sized allowing for personal carriage of said voice recorder/player.

4. The system for daily meditation of the Bible of claim 1 wherein said textual display is pocket sized for personal carriage of said textual display.

5. The system for daily meditation of the Bible of claim 1 wherein said textual display is a booklet having a plurality of daily sections.

6. The system for daily meditation of the Bible of claim 1 wherein said voice recorder/player includes a first voice recorder/player and a second voice recorder/player which is shaped as a heart when positioned adjacent to each other;
whereby said first voice recorder/player is carried by the user and the second voice recorder/player is carried by a spouse of the user, the user recording the selected verse into the spouse's voice recorder/player and the spouse recording the selected verse into the user's voice recorder/player.

7. A system for daily meditation of the Bible, the system comprising:
a textual display providing textual information on a biblical topic, said textual display being pocket sized for personal carriage by the user; and
a voice recorder/player for recording a selected biblical verse from said textual display, said voice recorder/player being pocket sized for personal carriage by the user and having an appearance of the Bible;
whereby a user periodically studies said textual display and records the selected biblical verse for playback, the playback of the biblical verse assisting in the memorization of the biblical verse.

8. A method of assisting a user in daily biblical meditation, said method comprising the steps of:
selecting, by the user, of a daily meditation displayed on a textual display;
studying, by the user, the textual display;
recording, by the user, into a voice recorder/player a desired biblical verse;
carrying the textual display by the user;
carrying the voice recorder/player by the user;
reviewing the textual display periodically by the user; and
replaying the recorded verse periodically by the user to assist in memorizing the recorded verse.

9. The method of assisting a user in daily biblical mediation of claim 8 wherein the voice recorder/player is shaped as a Bible.
